(19) United States
(12) Patent Application Publication
(10) Pub. No.: US 2019/0113035 A1
(43) Pub. Date: Apr. 18, 2019

(54) OPTIMIZED ENERGY RECOVERY DEVICE ROTOR

(71) Applicant: EATON INTELLIGENT POWER LIMITED, Dublin (IE)

(72) Inventors: Matthew Gareld SWARTZLANDER, Battle Creek, MI (US); David YEE, West Bloomfield, MI (US)

(21) Appl. No.: 16/083,227

(22) PCT Filed: Mar. 9, 2017
(86) PCT No.: PCT/US2017/021524

§ 371 Date: Sep. 7, 2018

Related U.S. Application Data
(60) Provisional application No. 62/305,849, filed on Mar. 9, 2016.
(60) Provisional application No. 62/319,390, filed on Apr. 7, 2016.

(51) Int. Cl. F04C 18/18; F03B 17/06; H02K 7/116; H02K 7/18

(52) U.S. Cl. CPC F04C 18/18; H02K 7/1823; H02K 7/116; F03B 17/06

(57) ABSTRACT

The present teachings include an energy recovery device usable in multiple applications, for example hydropower and vehicle power plant applications. In one aspect, an energy recovery device includes a housing having an inlet and an outlet in fluid communication with an internal cavity, and a pair of counter-rotating rotors having intermeshed lobes disposed within the housing internal cavity. Each rotor defines a transport volume between the housing and a pair of adjacent lobes and has a calculated maximum ideal twist angle below which the transport volume will be sealed from both the housing inlet and housing outlet. Each rotor also has an actual twist angle that exceeds the maximum ideal twist angle.

### CROSS-REFERENCE TO RELATED APPLICATIONS

This application is being filed on Mar. 9, 2017 as a PCT International Patent Application and claims the benefit of U.S. Patent Application Ser. No. 62/305,849, filed on Mar. 9, 2016, and claims the benefit of U.S. Patent Application Ser. No. 62/319,390, filed on Apr. 7, 2016, the disclosures of which are incorporated herein by reference in their entireties.

### TECHNICAL FIELD

This application relates to an optimized energy recovery device and systems thereof.

### BACKGROUND

An ideal twist angle of a Roots style compressor rotor is based on the bore diameter and center distance of the rotors. This ideal twist angle, which is the number of degrees each lobe turns from one end of the rotor to the other end, is used to set the limit for twist before a leak is created between the inlet and outlet port of the compressor. The ideal twist angle and the length of the rotors can be used to set the helix angle of the rotor. By utilizing rotors with less twist than the ideal twist angle, the supercharger can be tuned to perform better at different operating conditions. This is done by dividing the available event timing, which is the difference in the ideal twist angle and the actual twist angle, into seal timing and dwell timing. However it has been demonstrated that utilizing a rotor twist angle higher than the ideal twist angle is detrimental. In expanders, Roots-type rotors have been used that have a rotor twist angle lower than the ideal twist angle.

### SUMMARY

An optimized energy recovery device is presented, and in particular Roots-style rotors used in turbine and expander applications. In contrast to conventional Roots-style rotors optimized for operation in an expander or compressor, the disclosed rotors are provided with an actual twist angle that is higher than the ideal twist angle. Thus, the disclosed energy recovery devices do not seal off the inlet from the outlet and instead allows for a leakage path. This leakage path creates a torturous flow path through the rotors imparting a moment on the shafts from the increased fluid velocity to generate rotation within the energy recovery device. The increased fluid velocity flow through assists in the conversion of kinetic energy in the fluid stream into the rotor's rotation. Accordingly, it has been discovered that Roots-style energy recovery devices benefit from negative seal time. The leakage path becomes an orifice within the energy recovery device that can be sized by adjusting the degree of twist for a given energy recovery device size and application conditions.

In one example, an energy recovery device is presented that includes a housing having an inlet and an outlet in fluid communication with an internal cavity, and a pair of counter-rotating rotors having intermeshed lobes disposed within the housing internal cavity. Each rotor defines a transport volume between the housing and a pair of adjacent lobes and has a calculated maximum ideal twist angle below which the transport volume will be sealed from both the housing inlet and housing outlet in at least one rotational position of the rotors. Each rotor also has an actual twist angle that exceeds the maximum ideal twist angle. Implementations of the disclose energy recovery devices include use in a power generation system in which an output shaft of the energy recovery system is coupled to an input shaft of an electrical generator such that energy captured by the energy recovery device is converted to electrical power. The power generation system can be used in multiple applications, for example in a hydropower applications wherein the energy recovery device receives water from a headwater side of a dam structure and discharges the water to a lower elevation tailwater on an opposite side of the dam to rotate the rotors of the energy recovery device and generate power at the electrical generator.

Additional objects and advantages will be set forth in part in the description which follows, and in part will be obvious from the description, or may be learned by practice of the teachings presented herein. The objects and advantages will also be realized and attained by means of the elements and combinations particularly pointed out in the appended claims. It is to be understood that both the foregoing general description and the following detailed description are exemplary and explanatory only and are not restrictive of the claimed invention.

### BRIEF DESCRIPTION OF THE DRAWINGS

FIG. 1 is a schematic view of a hydropower system including an energy recovery device having features that are examples of aspects in accordance with the principles of the present disclosure.

FIG. 2 is a schematic view of a vehicle having a volumetric energy recovery device having features that are examples of aspects in accordance with the principles of the present disclosure.

FIG. 3 is a schematic side view of an energy recovery device usable with the systems shown in FIGS. 1 and 2.

FIG. 4 is a schematic end view of an inlet of the energy recovery device shown in FIGS. 1 and 2.

FIG. 5 is a schematic showing geometric parameters of the rotors of the energy recovery device shown in FIGS. 1 and 2.

FIG. 6 is a top perspective view of a physical example of the volumetric energy recovery device depicted in FIGS. 1-5.

FIG. 7 is a bottom perspective view of the energy recovery device shown in FIG. 6.

FIG. 8 is a top view of the energy recovery device shown in FIG. 6.

FIG. 9 is a bottom view of the energy recovery device shown in FIG. 6.

FIG. 10 is a front view of the energy recovery device shown in FIG. 6.

FIG. 11 is a cross-sectional view of the energy recovery device shown in FIG. 6, taken along the line A-A shown in FIG. 10.

FIG. 12 is a cross-sectional view of the energy recovery device shown in FIG. 6, taken along the line B-B shown in FIG. 10.

FIG. 13 is a cross-sectional view of the energy recovery device shown in FIG. 6, taken along the line C-C shown in FIG. 10.

FIG. 14 is a cross-sectional view of the energy recovery device shown in FIG. 6, taken along the line C-C shown in FIG. 10, with the additional depiction of a leakage path through the rotors and resulting moment imparted onto the rotor shafts being schematically shown.

FIG. 15 is a schematic side view of a second example of an energy recovery device usable with the systems shown in FIGS. 1 and 2.

FIG. 16 is a schematic top view of the energy recovery device shown in FIG. 15.

FIG. 17 is a schematic bottom view of the energy recovery device shown in FIG. 15.

FIG. 18 is a schematic inlet view, taken from line 18-18 at FIG. 15, of the energy recovery device shown in FIG. 15.

FIG. 19 is a schematic outlet view, taken from line 19-19 at FIG. 15, of the energy recovery device shown in FIG. 15.

FIG. 20 is a cross-sectional view of the energy recovery device shown in FIG. 15, taken along the line 20-20 in FIG. 17.

FIG. 21 is a side view of a rotor usable in the energy recovery device shown in FIG. 15.

FIG. 22 is an end view of the rotor shown in FIG. 15.

FIG. 23 is an end view of the rotor shown in FIG. 15.

FIG. 24 is a graphical representation of an inlet volume of a rotor of the energy recovery device shown in FIG. 2 as the rotor rotates through a full rotation in comparison to a non-optimized rotor that does not define a leakage path.

FIG. 25 is a graphical representation of a torque output of a rotor of the energy recovery device shown in FIG. 2 during operation.

### DETAILED DESCRIPTION

This disclosure is related to energy recovery devices and power generation systems for use in multiple applications. In one example, the disclosed power generation systems are usable in hydropower applications wherein one or more energy recovery devices is configured as a turbine coupled to a generator for the purpose of electrical power generation. In such applications, one or more energy recovery devices can be installed at an existing dam location or any other location where a water flow undergoes an elevation change. In another example, the disclosed energy recovery devices are usable in vehicle power plant applications where waste heat energy from the vehicle power plant is captured and returned to the power plant. The disclosed energy recovery devices and power generation systems may be used in other applications as well, for example in marine and agricultural industries.

### Systems Including Energy Recovery Devices

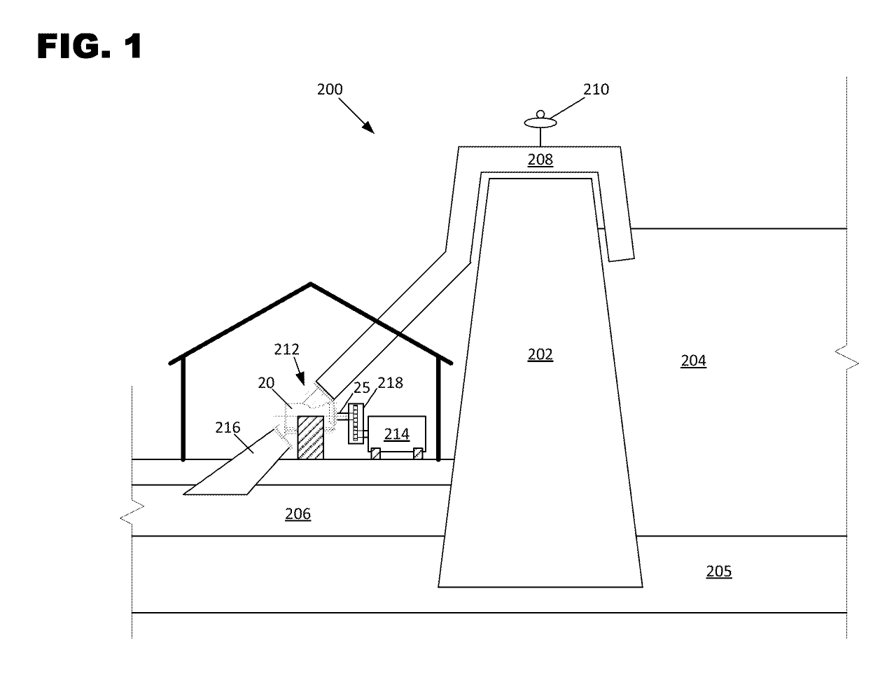

Referring to FIG. 1, a hydropower system 200 is shown in which a dam structure 202 is built upon a ground structure 205 and constructed to retain a headwater pool 204. In the example shown, the dam 202 is an existing non-powered dam, such as a concrete structure. Water from the headwater pool 204 can be transferred to tailwater 206 via a penstock structure 208. The penstock structure 208 is shown as being entirely external of the dam structure 202, but could be defined as an internal passageway within the dam structure 202. Water flow through the penstock structure 208 can be selectively controlled by an intake gate valve 210. The hydropower system 200 can also include a power generation system 212 including an energy recovery device 20 functioning as a turbine and including an electric generator 214 driven by the energy recovery device 20 via a power transmission link 25. As shown, a gearbox assembly 218 is placed between the energy recovery device 20 and the generator 214 that allows for the output shaft of the energy recovery device 20 to operate at a different speed than the input shaft of the generator. In one example, the gearbox assembly 218 is configured in a “step up” arrangement in which the internal gearing results in the generator input shaft rotating at a higher speed than the output shaft of the energy recovery device 20. The reverse arrangement is also possible, wherein a “step down” arrangement is provided such that the generator input shaft operates at a lower speed in comparison to the energy recovery device output shaft. The gearbox assembly 218 can also be configured such that the respective input and output shafts rotate at the same speed. In yet another alternative, the gearbox assembly 218 can be configured such that the gearing ratio can be selectively changed during operation. In a more simple approach, the output shaft of the energy recovery device 20 can be directly coupled to the input shaft of the generator 214.

As shown, the inlet of the energy recovery device 20 is shown as being connected to the penstock structure 208 while the outlet of the energy recovery device is shown as being connected to a draft tube 216 which is in fluid communication with the tailwater 206. In operation, water flows from the headwater pool 204, through the penstock structure 208, through the energy recovery device 20, and into the tailwater 206 via the draft tube 216. As water passes through the energy recovery device 20, rotors within the energy recovery device 20 are forced to rotate by the force of the flowing water. The rotation of the rotors in turn causes the generator 214 to rotate to generate electrical power, which can be delivered to an electrical power bus and to a power grid via power transmission lines (not shown). The power generation system 212 may be used in other applications where a flowing fluid source is present.

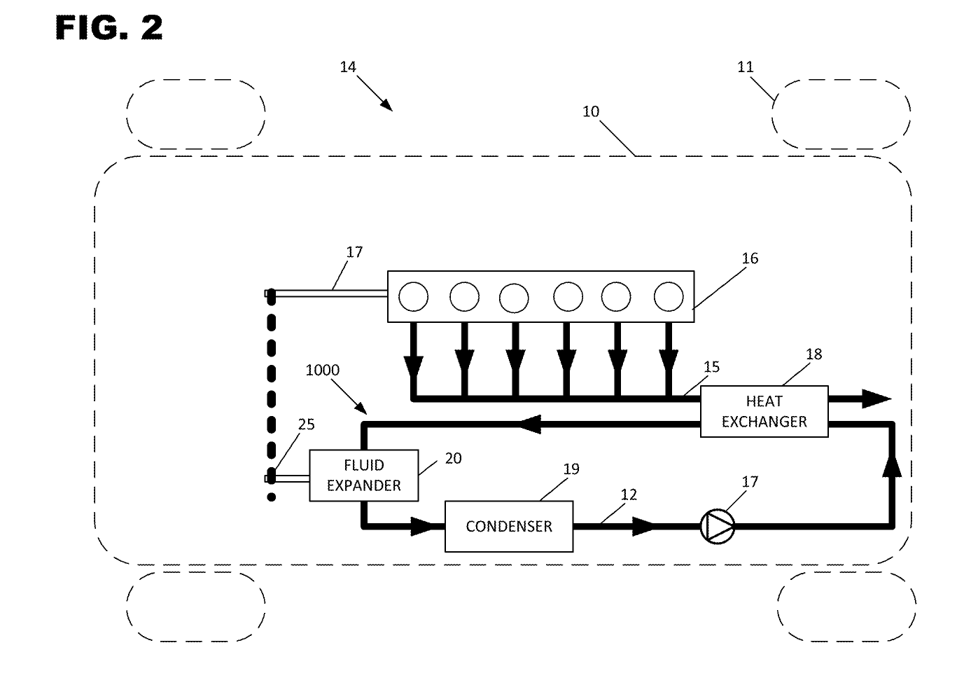

Referring to FIG. 2, another application of the disclosed energy recovery device 20 is shown in which the energy recovery device 20 captures and returns waste heat energy to a vehicle power plant as part of a power-generation system 14. As shown, a vehicle 10 having wheels 11 for movement along an appropriate road surface includes a power-generation system 14. The system 14 includes a power-plant 16 employing a power-generation cycle. The power-plant 16 uses a specified amount of oxygen, which may be part of a stream of intake air, to generate power. The power-plant 16 also generates waste heat such in the form of a high-temperature exhaust gas in exhaust line 15 a byproduct of the power-generation cycle. In one embodiment, the power-plant 16 is an internal combustion (IC) engine, such as a spark-ignition or compression-ignition type which combusts a mixture of fuel and air to generate power. In one embodiment, the power-plant 16 may be or a fuel cell which converts chemical energy from a fuel into electricity through a chemical reaction with oxygen or another oxidizing agent.

The vehicle 10 may also include an energy recovery device, for example volumetric energy recovery device 20, which recovers energy from the power-plant 16 waste heat to improve the efficiency of the power-plant 16.

In one embodiment, and as shown in FIG. 2, an organic Rankine cycle (ORC) is used to recover energy from the waste heat. In such an embodiment, a piping system 1000 including a heat exchanger 18 is provided that transfers heat from the exhaust gas line 15 to a working fluid 12 that is then delivered to the volumetric energy recovery device 20. The working fluid 12 may be an alcohol (such as methanol or ethanol), a hydrocarbon (such as n-pentane, toluene, or dodecane), a refrigerant (such as R-245fa) or a mixture of solvents (such as ammonia-water or water-ethanol). A condenser 19 is also provided which creates a low pressure zone for the working fluid 12 and thereby provides a location for the working fluid 12 to condense. Once condensed, the working fluid 12 can be delivered to the heat exchanger 18 via a pump 17. A more detailed description of an ORC system being utilized to drive an energy recovery device 20 is provided in Patent Cooperation Treaty (PCT) International Application Publication Number WO 2013/30774 entitled VOLUMETRIC ENERGY RECOVERY DEVICE AND SYSTEMS. WO 2013/30774 is hereby incorporated herein by reference in its entirety. The volumetric energy recovery device 20 may also be utilized in a direct exhaust gas heat recovery process wherein the exhaust gas is the working fluid 12, as disclosed in Patent Cooperation Treaty (PCT) International Application Publication Number WO 2014/107407, the entirety of which is incorporated by reference herein. Additional expander systems are disclosed in Patent Cooperation Treaty (PCT) International Application Publication Number WO 2014/117159, the entirety of which is incorporated by reference herein.

In one aspect, the energy recovery device 20 may also include a power output device 25 configured to transfer useful work from the energy recovery device 20. Such mechanical work generated by the rotation of the output shaft 38 (discussed later) of the energy recovery device 20 may be delivered to any elements or devices as necessary. For example, the output shaft 38 can be directly or indirectly coupled to another power plant, the vehicle 10 powertrain, another energy recovery device, a turbocharger, a supercharger, a generator, a motor, a hydraulic pump, and/or a pneumatic pump via gears, belts, chains or other structures. In some examples, the recuperated energy may be accumulated in an energy storage device, such as a battery or an accumulator, and the energy storage device may release the stored energy on demand. In other examples, the recovered energy may return to the power plant 16 by mechanically coupling the output shaft of the device 20 to a power input location 17 (e.g. a crankshaft of an engine). A power transmission link 25 may also be employed between the volumetric fluid energy recovery device 20 and the power plant 16 to provide a better match between rotational speeds of the power plant 16 and the output shaft of the device 20. In some embodiments, the power transmission link 25 can be configured as a planetary gear set to provide two outputs for the power plant 16 and a generator.

### Energy Recovery Device General Construction

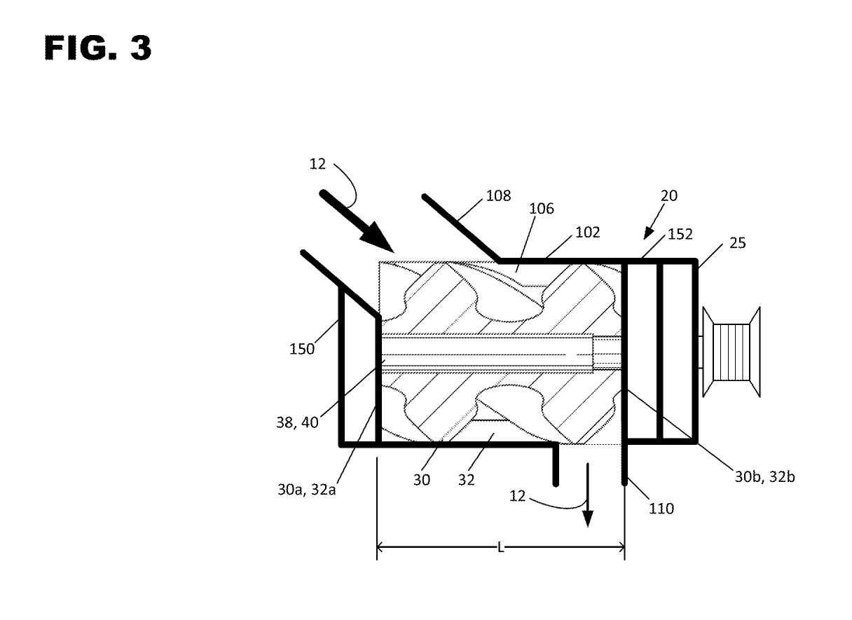

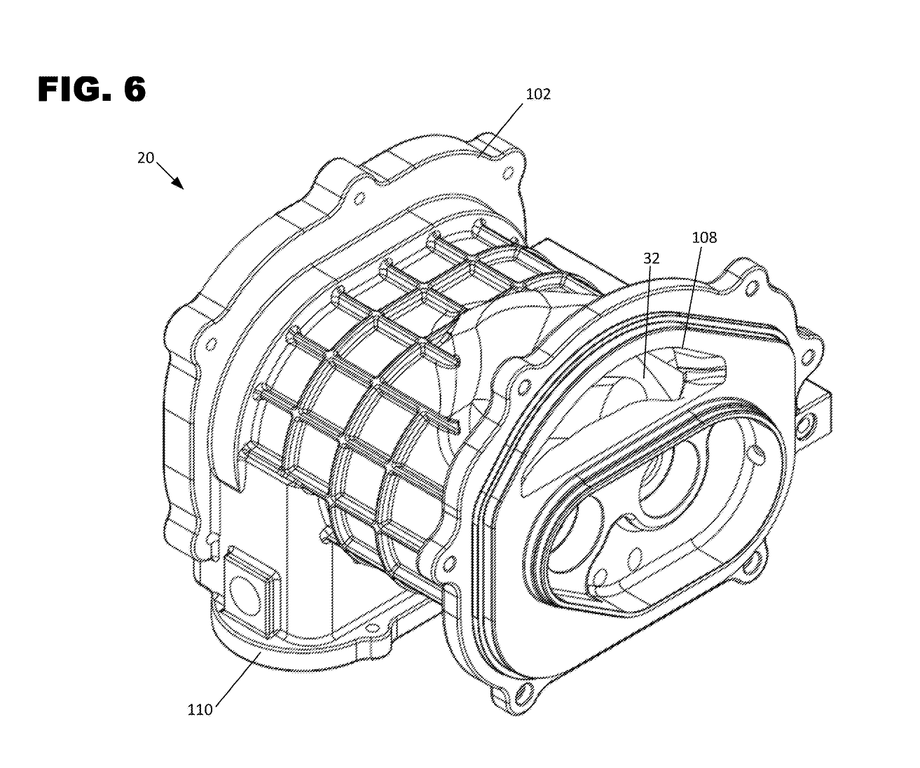

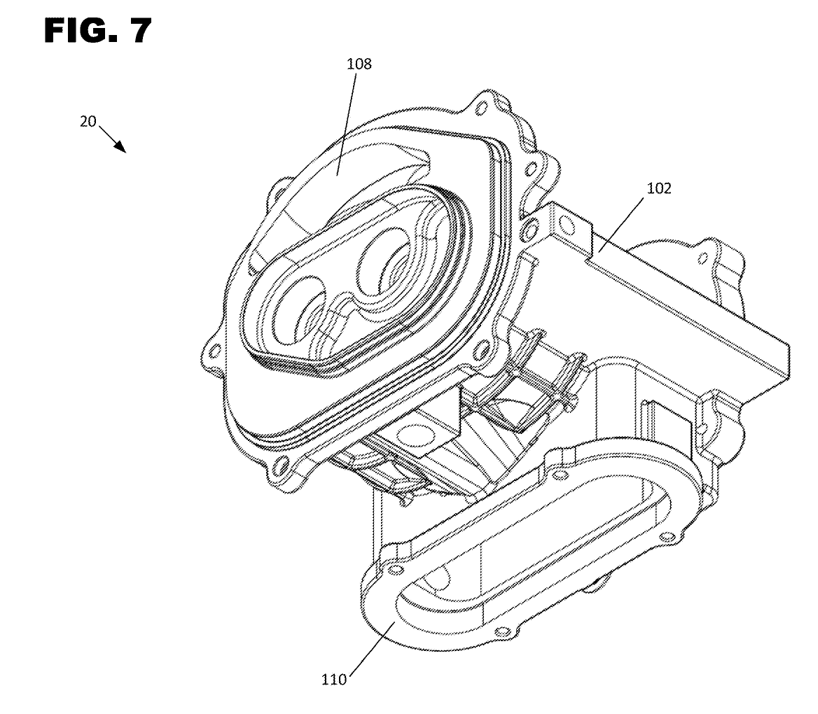

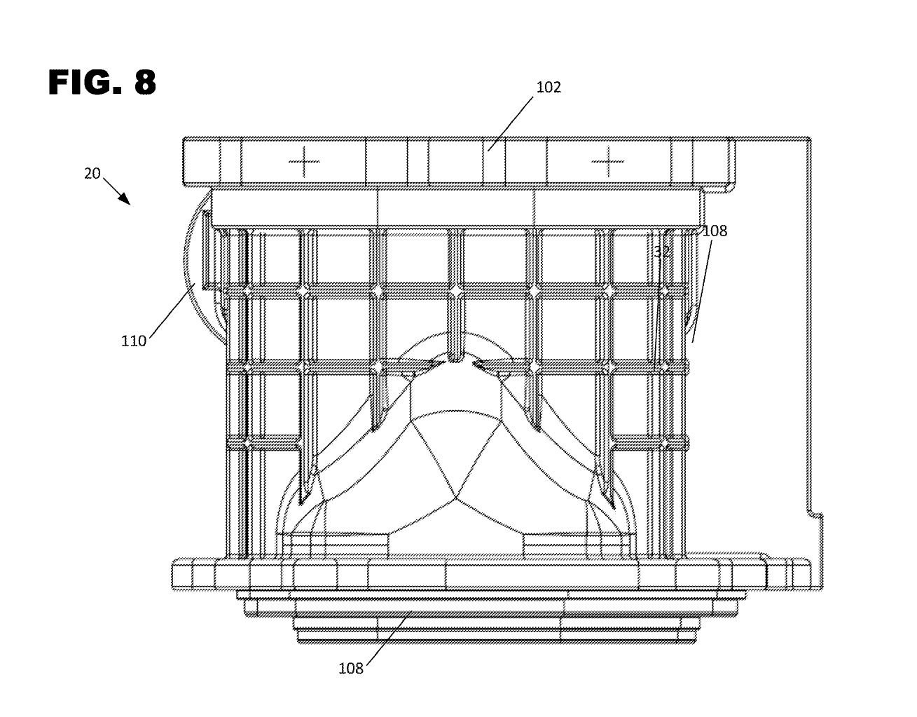

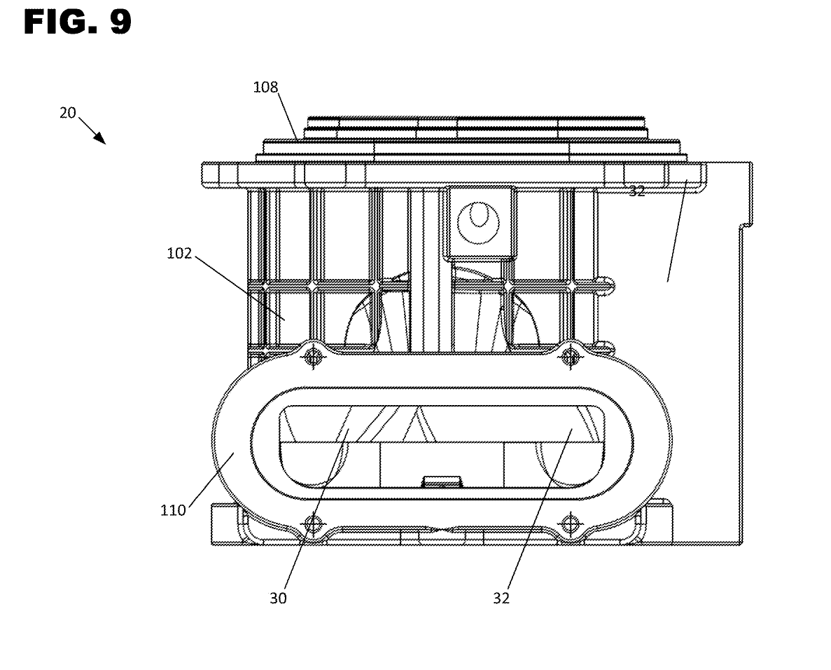

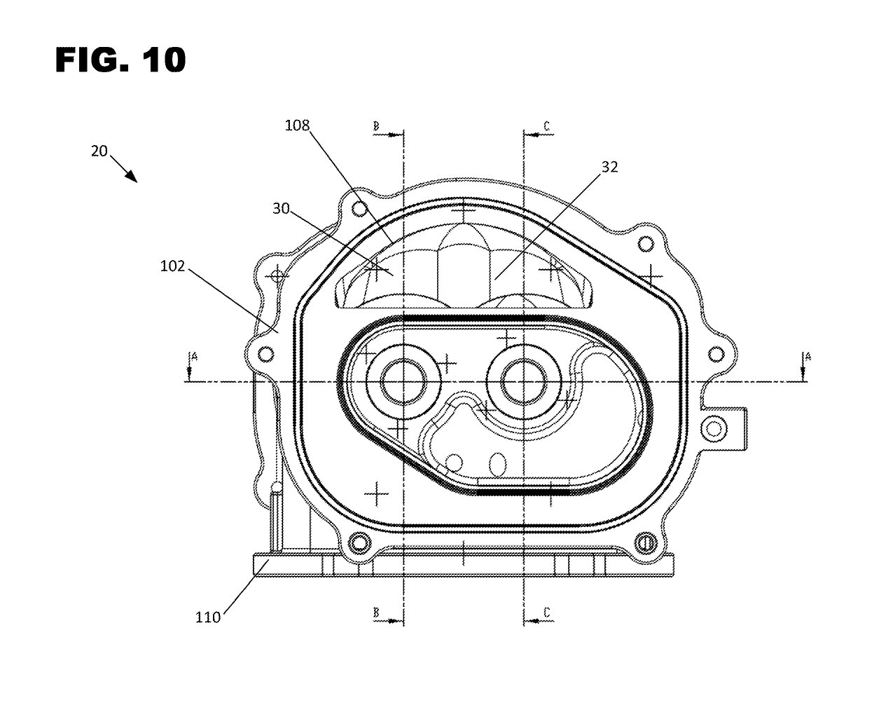

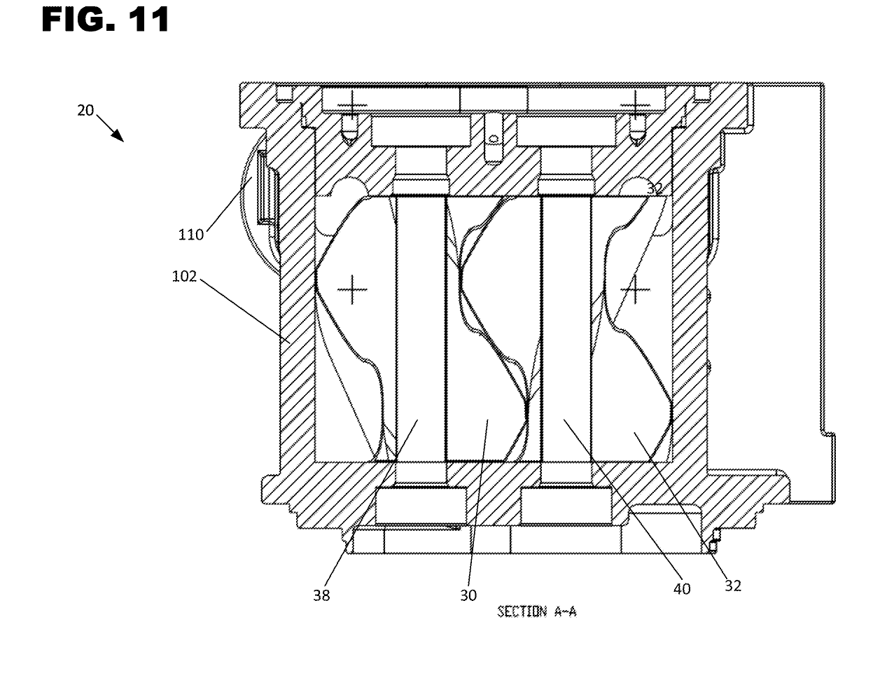

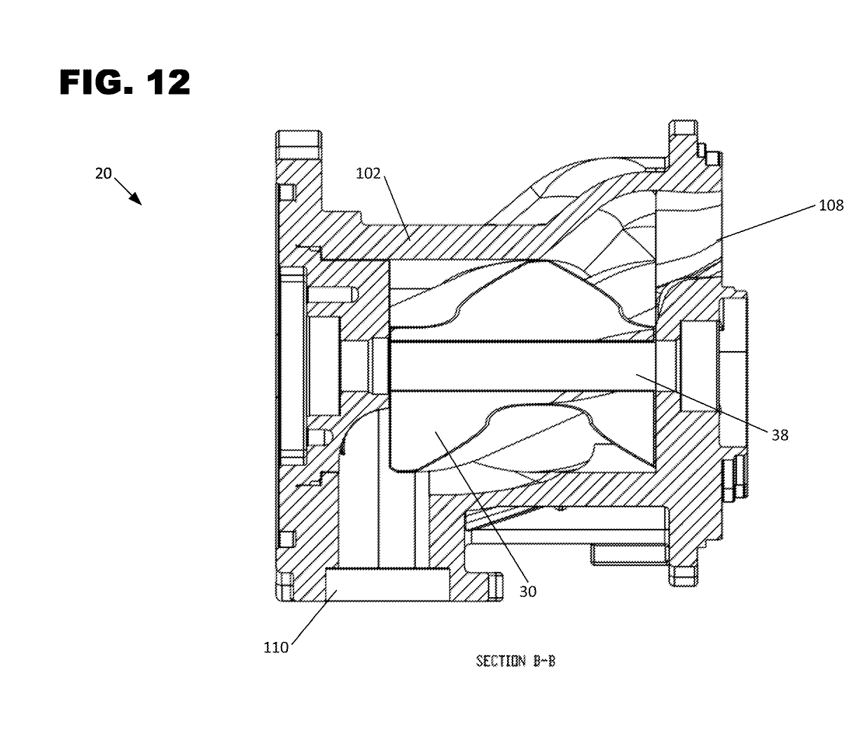

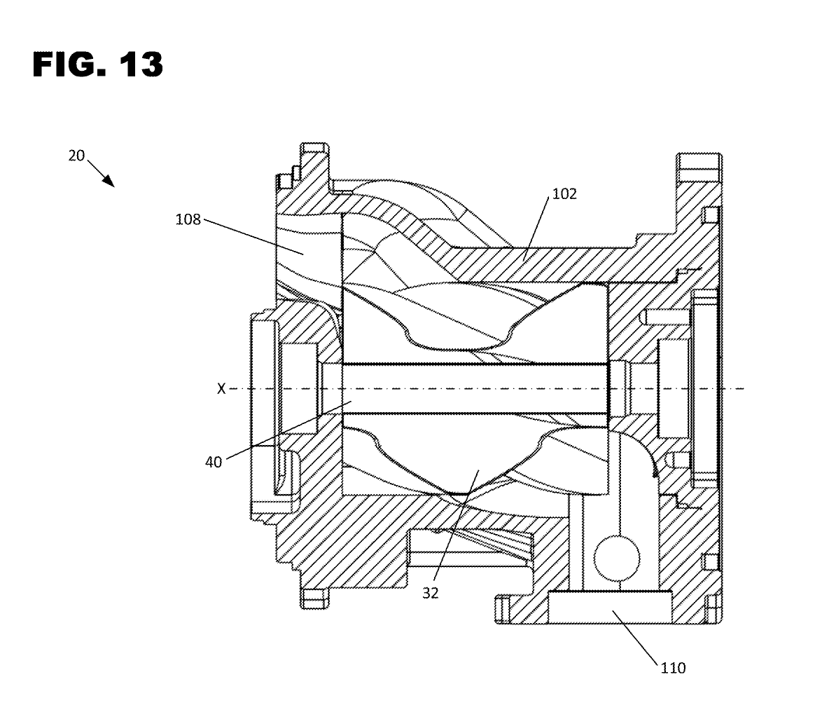

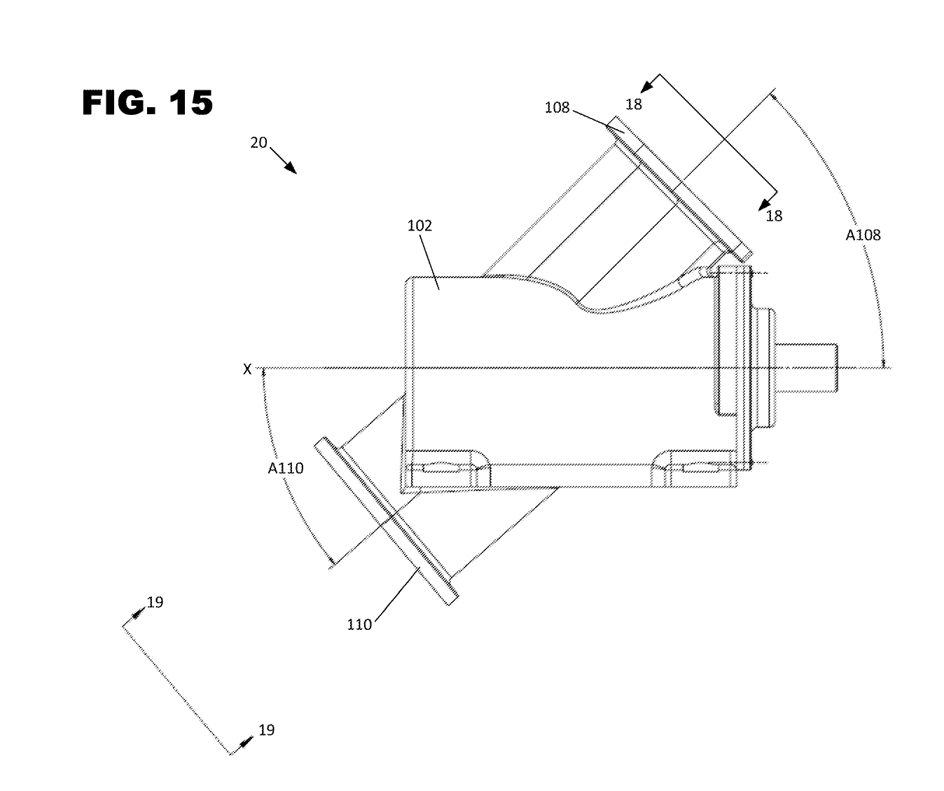

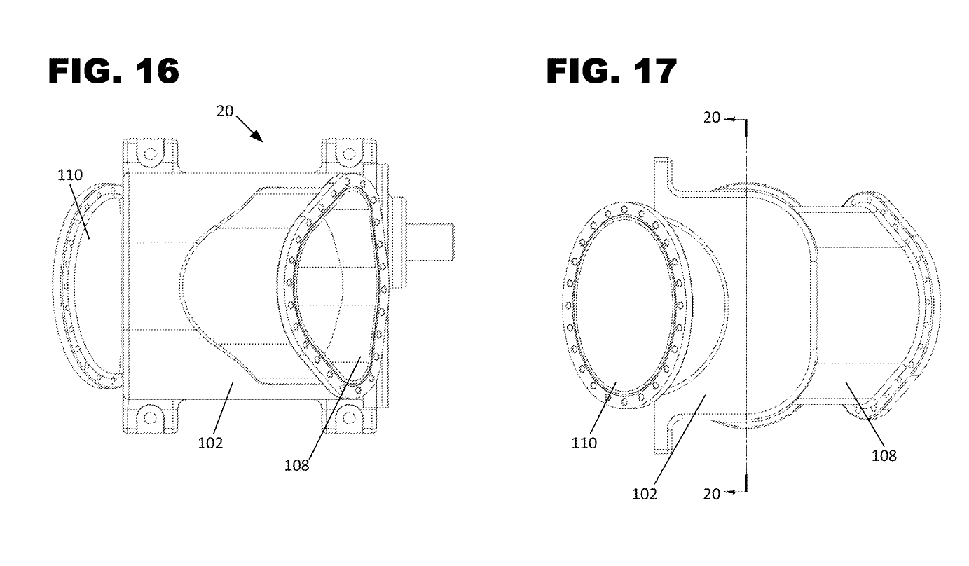

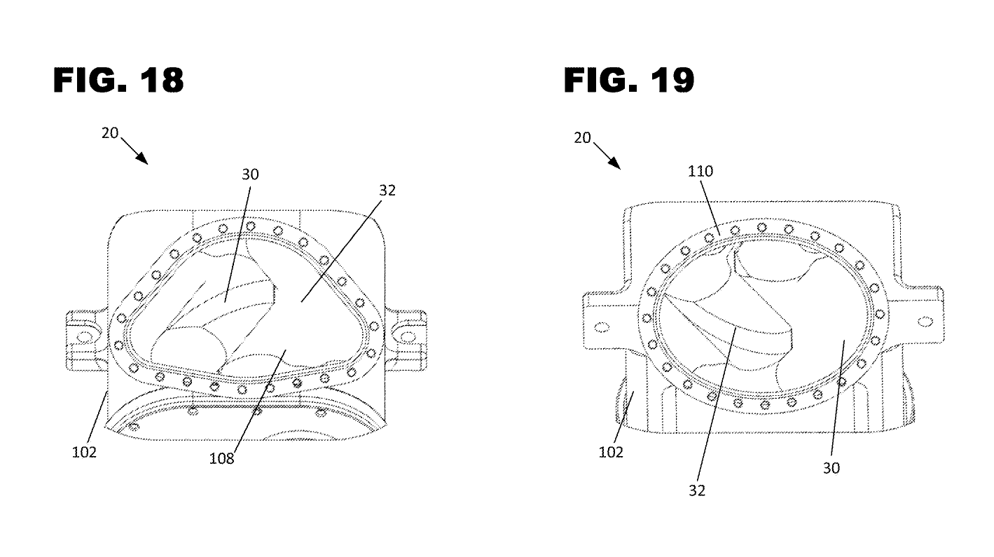

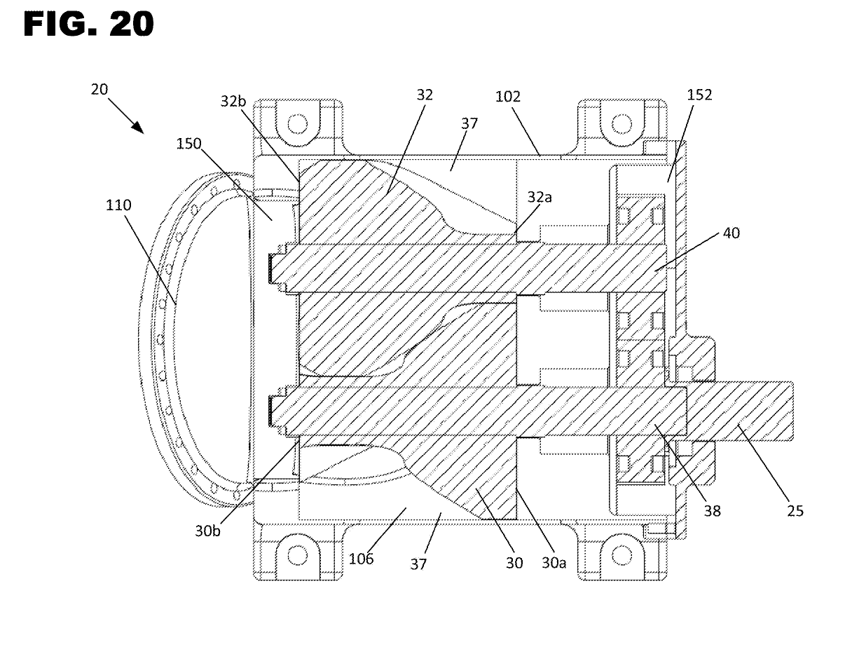

Referring to FIGS. 3-5, a volumetric energy recovery device 20 in accordance with the present teachings is shown in schematic form. FIGS. 6-13 show a first physical embodiment of the energy recovery device 20 while FIGS. 15-23 show a second physical embodiment of the energy recovery device 20. The following description is fully applicable to each of the first and second physical embodiments, unless otherwise noted. As shown at FIGS. 3-5, the energy recovery device 20 includes a main housing 102 that defines a first working fluid passageway 106 extending between a first inlet 108 and a first outlet 110. With the first physical embodiment, as most easily viewed at FIG. 13, the inlet 108 is disposed generally parallel to the longitudinal axis X of the energy recovery device while the outlet 110 is disposed generally orthogonally to the longitudinal axis X. With the second physical embodiment, as most easily viewed at FIG. 15, the inlet 108 is disposed at a first oblique angle A108 with respect to the longitudinal axis X while the outlet 110 is disposed a second oblique angle A110 with respect to the longitudinal axis. In one example, the first oblique angle is 45 degrees while the second oblique angle is 40 degrees. With continued reference to FIG. 15, the inlet and outlet angles, in combination with the relative locations of the inlet 108 and outlet 110 in an overlapping alignment between the inlet 108 and the outlet 110 that provides a “line-of-sight” through the energy recovery device 20 from the inlet 108 to the outlet 110, as can be also seen at FIGS. 18 and 19. Thus, the inlet 108 and outlet 110 of the second physical embodiment can be said to be generally coaxially aligned, meaning that the inlet 108 and outlet 110 are sufficiently aligned to provide for at least a portion of the outlet 110 to be viewed from within the inlet 108 along a line-of-sight, and vice-versa.

The energy recovery device 20 can also be provided with compartments 150, 152 to house bearings, timing gears, and/or step gears, for example, as explained in PCT Publication WO 2014/117159. Disposed within the working fluid passageway 106, is a pair of meshed rotors 30, 32. Each pair of meshed rotors 30, 32 is configured such that the rotors 30, 32 are overlapping or intermeshed, and rotate synchronously in opposite directions.

As the working fluid 12 passes through the inlet 108 across the meshed rotors 30, 32 and to the respective outlet 110, the working fluid 12 undergoes a pressure drop which imparts rotational movement onto the rotors 30, 32, thus creating mechanical work that can be input back into the power plant 16. Accordingly, the inlet port 108 is configured to admit the working fluid 12 at an entering pressure whereas the corresponding outlet port 110 is configured to discharge the working fluid 12 at a leaving pressure lower than the entering pressure. In such a configuration, the working fluid 12 enters inlet 108 at a first pressure and leaves outlet 110 at a second pressure lower than the first. In hydropower applications where the energy recovery device 20 is configured as a turbine, the rotors 30, 32 capture kinetic energy from the working fluid (i.e. water). In one embodiment, where the energy recovery device 20 is used in a Rankine cycle, the pressure drop from the inlet 108 to the outlet 110 is between about 2 bar and about 10 bar, for example 5 bar.

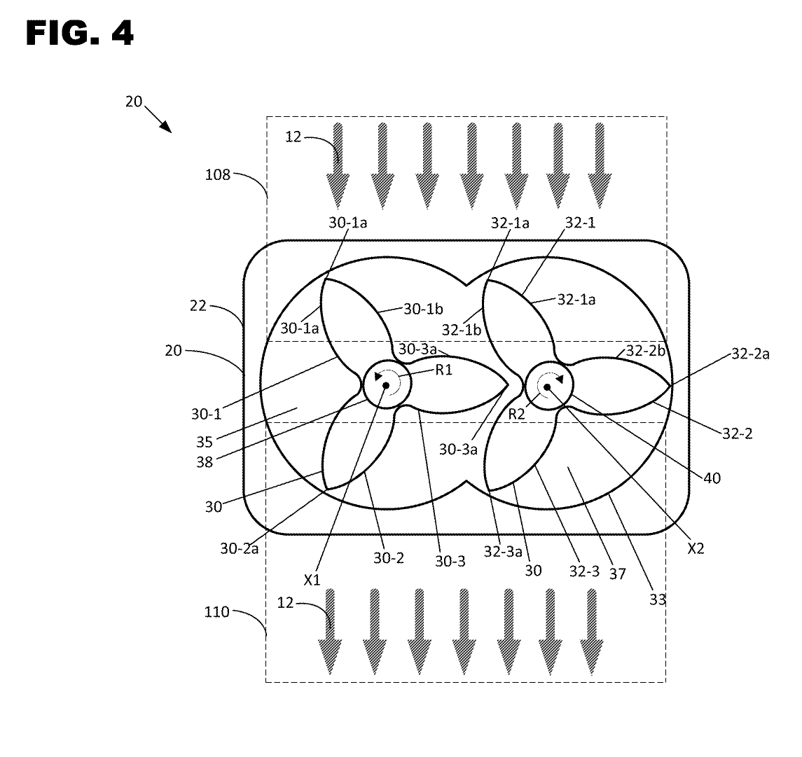

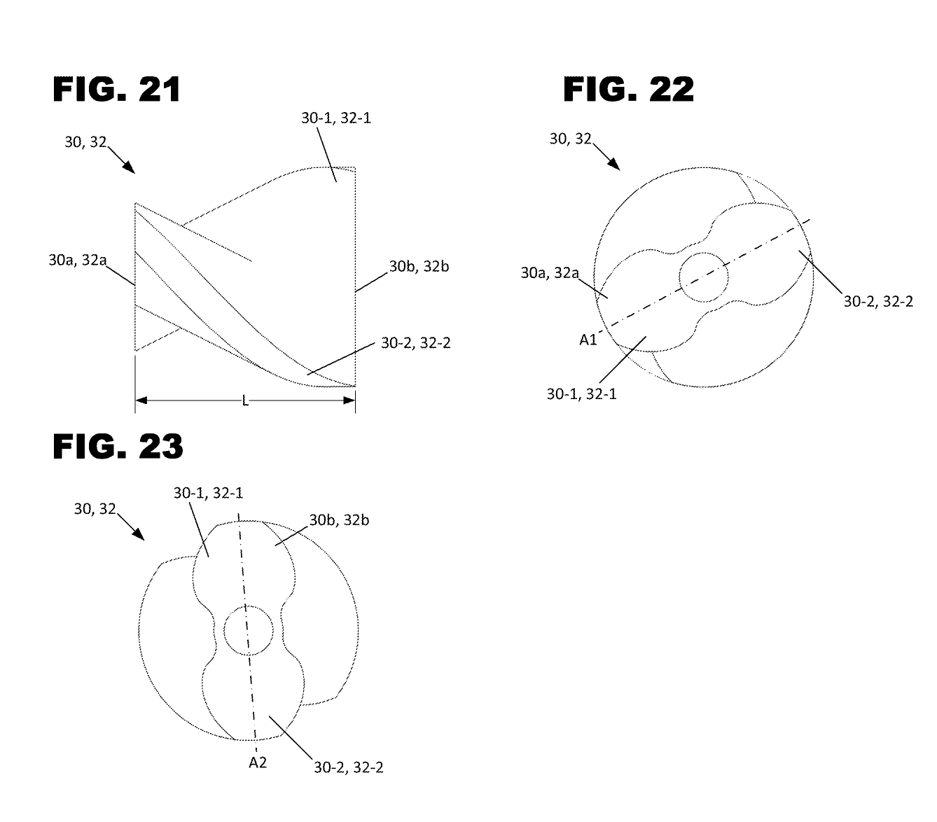

Each of the rotors 30, 32, as most easily seen at FIG. 4, is provided with a plurality of lobes. As shown, each rotor 30, 32 can be provided with three lobes, 30-1, 30-2, 30-3 in the case of the rotor 30, and 32-1, 32-2, 32-3 in the case of the rotor 32. As shown, each of the lobes 30-1 to 30-3 and 32-1 to 32-3 form a respective tip or cusp edge 30-1a to 30-3a and 32-1a to 32-3a. Although three lobes are shown for each rotor 30 and 32, each of the two rotors may have any number of lobes that is equal to or greater than two. For example, the embodiment shown at FIGS. 15-23 shows an energy recovery device with rotors have two lobes each, as most easily seen at FIGS. 21-23. Also, PCT Publication WO 2013/30774 shows a suitable rotor having four lobes.

As presented, the number of lobes is the same for each rotor 30 and 32. This is in contrast to the construction of typical rotary screw devices and other similarly configured rotating equipment which have a dissimilar number of lobes (e.g. a male rotor with “n” lobes and a female rotor with “n+1” lobes). Furthermore, one of the distinguishing features of the energy recovery device 20 is that the rotors 30 and 32 are identical, wherein the rotors 30, 32 are oppositely arranged so that, as viewed from one axial end, the lobes of one rotor are twisted clockwise while the lobes of the meshing rotor are twisted counter-clockwise. Accordingly, when one lobe of the rotor 30, such as the lobe 30-1 is leading with respect to the inlet port 108, a lobe of the rotor 32, such as the lobe 30-2, is trailing with respect to the inlet port 108, and, therefore with respect to a stream of the high-pressure fluid 12.

As previously mentioned, the first and second rotors 30 and 32 are interleaved and continuously meshed for unitary rotation with each other. In one embodiment, the lobes of each rotor 30, 32 are twisted or helically disposed along the length L of the rotors 30, 32. The length L can be defined as the distance between a first end 30a, 32a and a second end 30b, 32b of the respective rotors 30, 32. Upon rotation of the rotors 30, 32, the lobes, at the cusp edges, at least partially seal the fluid 12 against the interior structure or surface 33 of the housing 102 to define a transport volume 35, 37. In one aspect, the transport volume 35, 37 defined between the lobes and the interior structure or surface 33 of the housing is constant as the fluid 12 traverses the length of the rotors 30, 32. Thus, expansion of the fluid 12 only occurs to the extent allowed by leakage which represents an inefficiency in the system, in applications where the working fluid is expandable. Accordingly, energy recovery device 20 can be referred to as a “volumetric device” as the sealed or partially sealed fluid volume does not change wherein the working fluid 12 is generally not reduced or compressed.

In operation, rotor shafts 38, 40, respectively attached to rotors 30, 32, are rotated by the working fluid 12 as the fluid passes through the energy recovery device 20. Accordingly, the shafts 38, 40 are configured to capture the work or power generated by the rotors 30, 32 of the energy recovery device 20. As discussed previously, the work is transferred from the shafts 38, 40 as output torque from the energy recovery device 20 via output device 25.

### Rotor Geometry

In one aspect of the geometry of the energy recovery device 20, each of the rotor lobes 30-1 to 30-3 and 32-1 to 32-3 has a lobe geometry in which the twist of each of the first and second rotors 30 and 32 is constant along their substantially matching length L. Alternatively, the lobes 30, 32 can be provided without a twist although a drop in efficiency may be expected to occur.

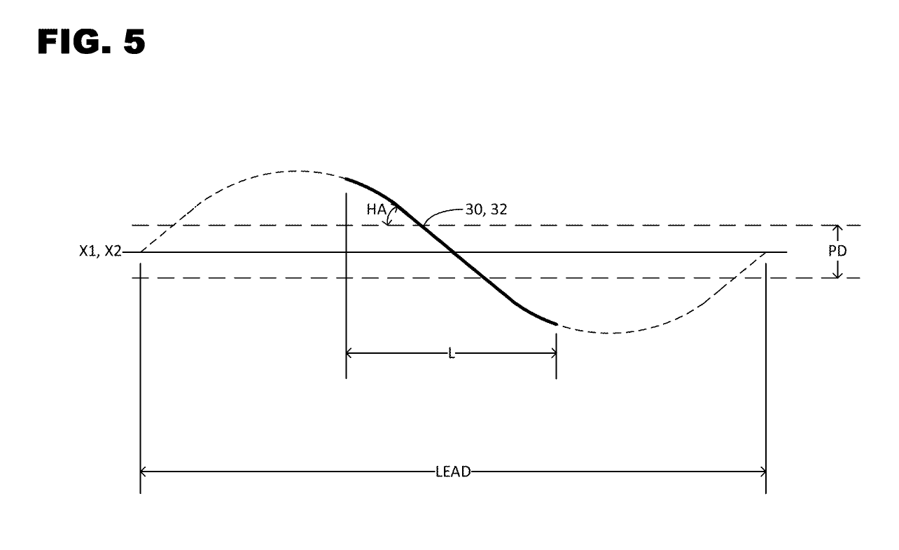

As shown schematically at FIG. 5, one parameter of the lobe geometry is the helix angle HA. By way of definition, it should be understood that references hereinafter to “helix angle” of the rotor lobes is meant to refer to the helix angle at the pitch diameter PD (or pitch circle) of the rotors 30 and 32. The term pitch diameter and its identification are well understood to those skilled in the gear and rotor art and will not be further discussed herein. As used herein, the helix angle HA can be calculated as follows: Helix Angle (HA)=(180/.pi.*arctan (PD/Lead)), wherein: PD=pitch diameter of the rotor lobes; and Lead=the lobe length required for the lobe to complete 360 degrees of twist. It is noted that the Lead is a function of the twist angle and the length L of the lobes 30, 32, respectively.

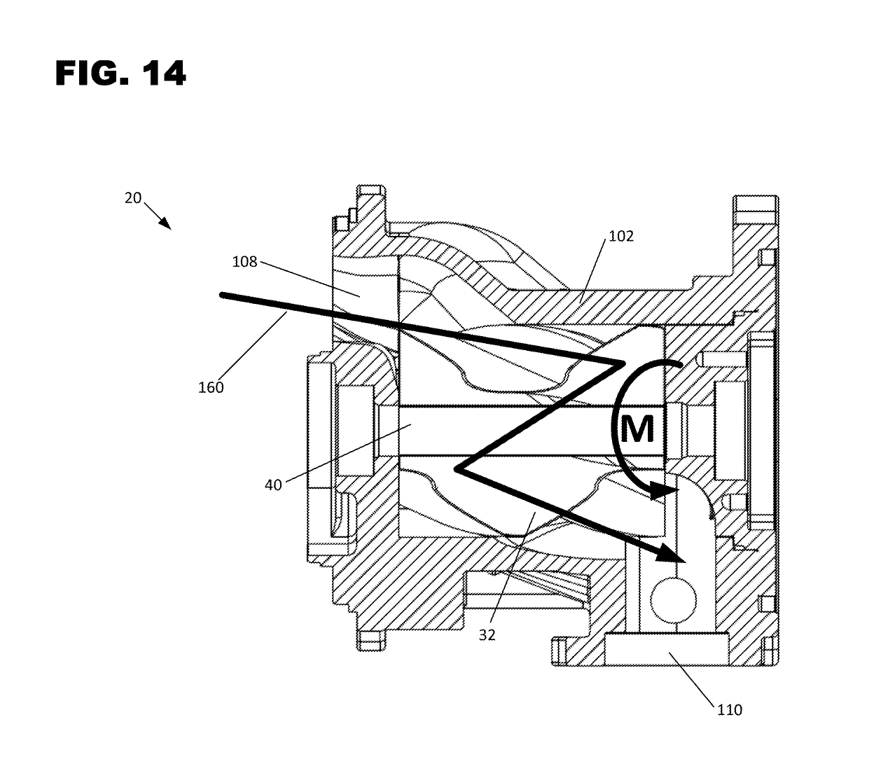

The twist angle is known to those skilled in the art to be the angular displacement of the lobe, in degrees, which occurs in “traveling” the length L of the lobe from the rearward end of the rotor to the forward end of the rotor. A further discussion on the concepts of twist angle and helix angle can be found at U.S. Pat. No. 7,488,164, the entirety of which is incorporated by reference herein. The “ideal twist” is the maximum twist angle through which the rotor 30, 32 can twist before a leak will occur between the inlet and the outlet of the energy recovery device via the transport volume 35, 37. In one example, a four lobe rotor 30, 32 has a diameter of 75 mm, a center distance of 50 mm, a length of 100 mm, a length to diameter ratio of 1.33, which results in the rotor 30, 32 having an ideal twist angle of 173.6 degrees.

Where the rotor 30, 32 is provided with a twist angle that exceeds the ideal angle, there would be no time at which the transport volume 35, 37 would be completely sealed off from the inlet 108 and outlet 110. In such a case, the inlet 108 and outlet 110 are in fluid communication with each other through all rotational angles of the rotor 30, 32 via a tortuous path defined by the transport volume between the rotor lobes. In the examples presented herein, the rotor 30, 32 is provided with a twist angle that exceeds the ideal angle for the rotor 30, 32. Such a configuration results in the rotors 30, 32 having negative seal timing (i.e. ideal angle—actual twist angle <0), meaning that there is no rotational angle at which the transport volume 35, 37 is sealed from both the inlet 108 and the outlet 110. As stated above, it has been determined that configuring rotors to have twist angles exceeding their ideal angles is advantageous in energy recovery device applications as the tortuous path existing between the inlet 108 and outlet 110 allows the fluid velocity (i.e. fluid kinetic energy) to generate rotation within the energy recovery device. This tortuous or leakage flow path 160, which defines an orifice within the energy recovery device 20, is schematically shown at FIG. 14. The increased fluid velocity flow assists in the conversion of energy in the fluid stream into the rotor's rotation by imparting an additional moment M on the rotor shafts (See FIG. 14). In one example, the above described rotor 30, 32 having an ideal angle of 173.6 degrees is provided with an actual twist angle of between about 175 degrees and 250 degrees, and is preferably provided with an actual twist angle of about 200 degrees for optimal energy recovery device operation. In the example shown at FIGS. 15-23, and as most easily seen at FIGS. 21-23, the rotors 30, 32 are provided with two lobes 30-1, 30-2 that have a twist angle of 120 degrees as the rotor lobes extend from the first end 30a, 32a from a starting angle A1 to a finishing angle A2 at the second end 30b, 32b.

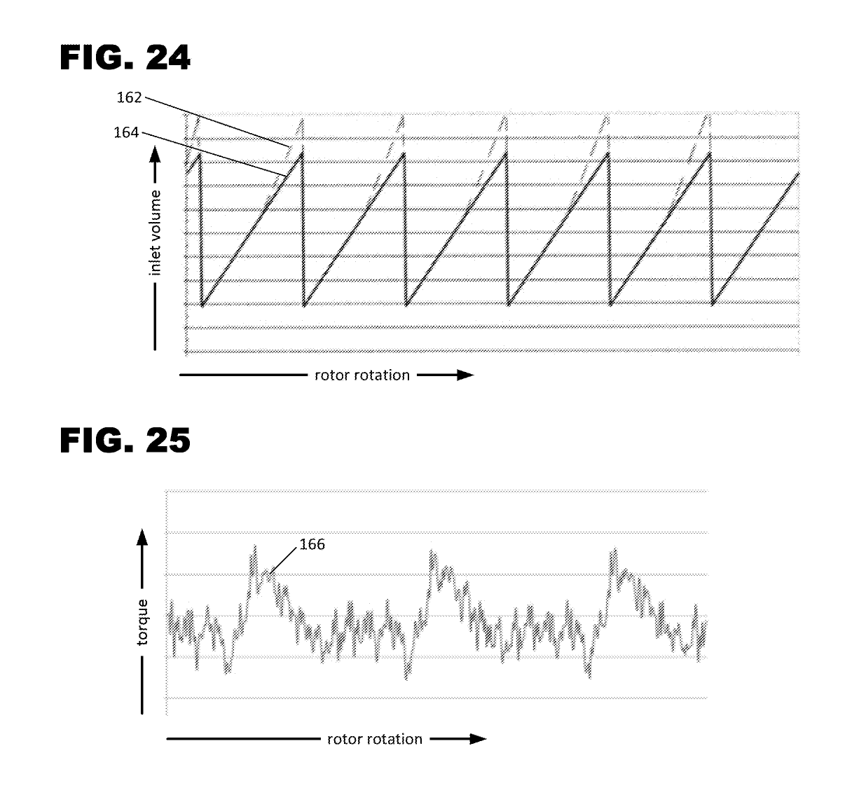

The amount of twist can be adjusted to change the size and timing of the desired orifice. Specific twists and inlet port timing allow this orifice to be presented to the inlet flow strategically in a manner that converts momentum into localized pressure in the inlet. The graph shown at FIG. 24 shows the inlet volume 162 of a twisted rotor 30, 32 as it traverses through inlet volume expanding and closing events, as compared to the inlet volume 164 of a rotor not provided with the leakage pathway 160. As shown, the rotor 30, 32 is configured to expose the designated orifice to the inlet volume prior to the closing event, thereby momentarily increasing the volume and mass flow higher than it would be without such timing. As a result, volume 162 shows a significantly higher peak in comparison to volume 162 during operation. Once the volume closes abruptly, a local pressure wave is generated on the trailing side of the rotor, thus increasing the output torque. By sizing and timing this event accurately, a sufficient pressure wave can be generated to impact on both rotors, thus increasing the torque further. A torque profile 166 for a single rotor, configured as previously described, is shown at FIG. 25 which shows the change in torque at the rotor during rotation.

Because the inlet port 108 introduces the fluid 12 to both the leading and trailing faces of each rotor 30, 32, the fluid 12 performs both positive and negative work on the energy recovery device 20. To illustrate, FIG. 4 shows that lobes 30-2, 30-3, 32-2, and 32-3 are each exposed to the fluid 12 through the inlet port opening 108. Each of the lobes has a leading surface and a trailing surface, both of which are exposed to the fluid at various points of rotation of the associated rotor. The leading surface is the side of the lobe that is forward most as the rotor is rotating in a direction R1, R2 while the trailing surface is the side of the lobe opposite the leading surface. For example, rotor 30 rotates in direction R1 thereby resulting in side 30-1a as being the leading surface of lobe 30-1 and side 30-1b being the trailing surface. As rotor 32 rotates in a direction R2 which is opposite direction R1, the leading and trailing surfaces are mirrored such that side 32-1a is the leading surface of lobe 32-1 while side 32-1b is the trailing surface.

In generalized terms, the fluid 12 impinges on the trailing surfaces of the lobes as they pass through the inlet port opening 108 and positive work is performed on each rotor 30, 32. By use of the term positive work, it is meant that the fluid 12 causes the rotors to rotate in the desired direction: direction R1 for rotor 30 and direction R2 for rotor 32. As shown, fluid 12 will operate to impart positive work on the trailing surface 30-1b of rotor 30-1. The fluid 12 is also imparting positive work on the trailing surface 32-2b of rotor 32-2. However, the fluid 12 also impinges on the leading surfaces of the lobes, for example surfaces 30-3a and 32-1a, as they pass through the inlet port opening thereby causing negative work to be performed on each rotor 30, 32. By use of the term negative work, it is meant that the working fluid 12 causes the rotors to rotate opposite to the desired direction, R1, R2.

Other implementations will be apparent to those skilled in the art from consideration of the specification and practice of the examples and teachings presented herein. It is intended that the specification and examples be considered as exemplary only, with the true scope of the invention being indicated by the following claims.

1. An energy recovery device comprising:
a) a housing having an inlet and an outlet in fluid communication with an internal cavity; and
b) a pair of counter-rotating rotors having intermeshed lobes disposed within the housing internal cavity, each rotor defining a transport volume between the housing and a pair of adjacent lobes;
c) wherein each rotor has a calculated maximum ideal twist angle below which the transport volume will be sealed from both the housing inlet and housing outlet at least at one rotational position of the rotors, and wherein each rotor is provided with an actual twist angle exceeding the maximum ideal twist angle.

2. The energy recovery device of claim 1, wherein each rotor has two lobes and an actual twist angle of about 120 degrees.

3. (canceled)

4. The energy recovery device of claim 1, wherein the housing has a longitudinal axis that is parallel to a length of the rotors, and wherein the housing inlet is disposed at a first oblique angle to the longitudinal axis and the housing outlet is disposed at a second oblique angle to the longitudinal axis.

5. (canceled)

6. (canceled)

7. The energy recovery device of claim 4, wherein the first oblique angle is about 45 degrees and the second oblique angle is about 40 degrees.

8. The energy recovery device of claim 4, wherein the housing inlet and housing outlet are generally coaxially aligned to provide a line-of-site through the housing from the inlet to the outlet.

9. The energy recovery device of claim 1, wherein the housing has a longitudinal axis that is parallel to a length of the rotors, and wherein one or both of the housing inlet and the housing outlet is disposed at an oblique angle to the longitudinal axis.

10. The energy recovery device of claim 1, wherein the transport volume is open to either the housing inlet or the housing outlet at all rotational angles of the rotor.

11. A power generation system comprising:
a) an electric generator having an input shaft;
b) energy recovery device comprising:
1) a housing having an inlet and an outlet in fluid communication with an internal cavity; and
2) a pair of counter-rotating rotors having intermeshed lobes disposed within the housing internal cavity, each rotor defining a transport volume between the housing and a pair of adjacent lobes;
3) wherein each rotor has a calculated maximum ideal twist angle below which the transport volume will be sealed from both the housing inlet and housing outlet at least at one rotational position of the rotors, and wherein each rotor is provided with an actual twist angle exceeding the maximum ideal twist angle;
4) an output shaft fixed to one of the pair of rotors, the output shaft being operably connected to the electric generator input shaft.

12. The power generation system of claim 11, wherein each rotor has two lobes and an actual twist angle of about 120 degrees.

13. The power generation system of claim 11, wherein the housing has a longitudinal axis that is parallel to a length of the rotors, wherein the housing inlet is disposed at a first oblique angle to the longitudinal axis, and wherein the housing outlet is disposed at a second oblique angle to the longitudinal axis.

14. The power generation system of claim 13, wherein the first oblique angle is about 45 degrees and the second oblique angle is about 40 degrees.

15. The power generation system of claim 13, wherein the housing inlet and housing outlet are generally coaxially aligned to provide a line-of-site through the housing from the inlet to the outlet.

16. The power generation system of claim 13, wherein the output shaft is operably connected to the electric generator input shaft through a gearbox assembly.

17. A hydropower system comprising:
a) a dam structure retaining a headwater;
b) a penstock placing the headwater in fluid communication with a tailwater disposed at a lower elevation than the headwater;
c) an electric generator having an input shaft;
d) energy recovery device comprising:
1) a housing having an inlet in fluid communication with the headwater via the penstock and an outlet in fluid communication the tailwater, the inlet and outlet being in fluid communication with an internal cavity of the energy recovery device; and
2) a pair of counter-rotating rotors having intermeshed lobes disposed within the housing internal cavity, each rotor defining a transport volume between the housing and a pair of adjacent lobes;
3) wherein each rotor has a calculated maximum ideal twist angle below which the transport volume will be sealed from both the housing inlet and housing outlet at least at one rotational position of the rotors, and wherein each rotor is provided with an actual twist angle exceeding the maximum ideal twist angle;
4) an output shaft fixed to one of the pair of rotors, the output shaft being operably connected to the electric generator input shaft.

18. The hydropower system of claim 17, wherein each rotor has two lobes and an actual twist angle of about 120 degrees.

19. The hydropower system of claim 17, wherein the housing has a longitudinal axis that is parallel to a length of the rotors, wherein the housing inlet is disposed at a first oblique angle to the longitudinal axis, and wherein the housing outlet is disposed at a second oblique angle to the longitudinal axis.

20. (canceled)

21. The hydropower system of claim 19, wherein the housing inlet and housing outlet are generally coaxially aligned to provide a line-of-site through the housing from the inlet to the outlet.

22. The hydropower system of claim 17, wherein the output shaft is operably connected to the electric generator input shaft through a gearbox assembly.

23. The power generation system of claim 11, wherein the transport volume is open to either the housing inlet or the housing outlet at all rotational angles of the rotor.

24. The hydropower system of claim 16, wherein the transport volume is open to either the housing inlet or the housing outlet at all rotational angles of the rotor.
